(19) United States
(12) Patent Application Publication
(10) Pub. No.: US 2002/0042763 A1
(43) Pub. Date: Apr. 11, 2002

(54) Apparatus and method for providing trade credit information and/or trade credit insurance information

(76) Inventors: Ranjini Pillay, New York, NY (US); John Salinger, Short Hills, NJ (US); Gretchen Hayes, New York, NY (US); Simon Ng, Manalapan, NJ (US); Elaine Gubbins, New York, NY (US); Lisa Margolis, Baldwin, NY (US); Norman Ross, Woodmere, NY (US)

Correspondence Address: Proskauer Rose LLP, Patent Department, 1585 Broadway, New York, NY, 10036, US

(21) Appl. No.: 09/876,683

(22) Filed: Jun. 7, 2001

Related U.S. Application Data
(60) Provisional application No. 60/211,918, filed on Jun. 16, 2000.

(51) Int. Cl. G06F 17/60

(52) U.S. Cl. 705/35

(57) ABSTRACT

A method for providing trade credit information to a user comprises storing financial information on a memory device, receiving a request from a user for trade credit information regarding a customer of the user, processing the request for trade credit information in conjunction with the stored information, generating a credit report which may include a customer credit limit, a customer credit quote, or a customer credit report, and transmitting the credit report to the user. In preferred embodiments of the invention, the user may also purchase trade credit insurance, monitor a customer account, and/or turn over an account to a collection agency for collection. Each of the embodiments may be purchased by the user as an integrated package or as stand alone modules.

### RELATED APPLICATIONS

This Application claims the benefit of priority of U.S. Provisional Patent Application Serial No. 60/211,918 which teaches and discloses an on-line integrated package for trade credit insurance, filed Jun. 16, 2000, the subject matter of which is hereby incorporated by reference herein.

### FIELD OF THE INVENTION

The present invention pertains to an apparatus and method for providing trade credit information and/or trade credit insurance information and, in particular, to an apparatus and method for providing trade credit information and/or trade credit insurance information which can provide information regarding the creditworthiness of a trading counterpart or customer as well as information for providing a trade credit insurance policy or product.

### BACKGROUND OF THE INVENTION

Traditionally, trade credit insurance has been sold by insurance agents to their customers in a completely manual manner. Generally, the insured would sign a binder agreement provided by the agent which did not specify the names of the insured's customers nor the credit limits for each of these customers. After a policy was issued by an underwriter and was conveyed to the insured by traditional means, the insured could use a computer to contact the underwriter's web site and enter information regarding the insured's customers. The insured would then disconnect from the web site, and the underwriter would notify the insured which of the insured's customers are covered by the issued policy and the limits of that coverage.

The foregoing method of selling trade credit insurance was very time consuming and expensive. Moreover, the foregoing method for selling trade credit insurance left the insured in the dark as to which of its customers would be covered and the extent of that coverage. In addition, the foregoing method of selling trade credit insurance did not provide any mechanism for monitoring the insured's customers to ensure that there were no inordinate delays in payment of their bills. Nor did the foregoing method for selling insurance provide any mechanism for collecting on overdue bills.

These deficiencies effectively prevented middle market companies, i.e., companies having sales in the range of about $25-$100 million dollars per year from making effective use of trade credit insurance.

These deficiencies are overcome by the novel methods and apparatus for an internet delivered insurance product disclosed which provides a business user with the ability to manage its trade credit. The user, which can be the insured or an agent acting on behalf of the insured, while online, can purchase a credit decision or report for any of its customers, which credit decision or report may include a suggested credit limit for that customer. Alternatively, the user can apply for and purchase trade credit insurance on line in a single session from an underwriter. The Internet delivered insurance product offers four functions through the internet preferably on a real time basis. These functions are:

(1) credit analysis of a user's customers, i.e., credit data and limits;

(2) insurance against uncollected receivables;

(3) monitoring of the user's customers; and

(4) collections management in the event of non-payment.

Traditionally, these four functions were offered by different providers and were implemented manually. The invention described herein provides all of these functions in a single integrated package while being implemented through the internet and preferably in real time.

### SUMMARY OF THE INVENTION

A method for providing trade credit information to a user comprises storing financial information on a memory device, receiving a request from a user for trade credit information regarding a customer, processing the request for trade credit information in conjunction with the stored information, generating a credit report for the customer, and transmitting the credit report to the user.

In a further embodiment of the invention, a method for providing trade credit insurance comprises the steps previously described and additionally, determining whether a trade credit insurance policy can be provided to the user, and offering said trade credit insurance policy to the user.

In another embodiment of the invention, a method is disclosed for monitoring the accounts payable of a user, comprising storing financial information concerning a user's customers, receiving a request from a user to monitor the customer financial information, processing the request to monitor the customer financial information in conjunction with the stored financial information, generating a customer report containing the customer financial information including at least customer payment information, customer non-payment information, or customer default information, determining whether a customer has failed to make a payment of an accounts payable or has defaulted on an accounts payable, generating a notification message, and transmitting the notification message to the user.

In a further embodiment of the invention, a method for collecting an accounts payable for a user comprises storing financial information regarding a user's customers, receiving a request from a user to monitor a customer account, processing the request to monitor the customer account in conjunction with the stored information, determining whether an accounts receivable has not been satisfied by a customer, generating an account collection message for placing the customer into collection, and transmitting the account collection message to a collection agent.

Each of the foregoing embodiments may be purchased by the user as an integrated package, or may be purchased by the user as separate modules.

Apparatus for carrying out each of the foregoing methods is also disclosed herein.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates a preferred embodiment method for utilizing the apparatus of FIG. 1, in flow diagram form;

FIGS. 4A, 4B and 4C illustrate another preferred embodiment method for utilizing the apparatus of FIG. 1, in flow diagram form;

FIGS. 5A and 5B illustrate still another preferred embodiment method for utilizing the apparatus of FIG. 1, in flow diagram form; and

FIGS. 6A and 6B illustrate yet another preferred embodiment method for utilizing the apparatus of FIG. 1, in flow diagram form.

### DESCRIPTION OF THE PREFERRED EMBODIMENTS

The present invention pertains to an apparatus and method for providing trade credit information and/or trade credit insurance information. The present invention can provide information regarding the creditworthiness of a trading counterpart or customer as well as information for providing a trade credit insurance policy or product.

The apparatus and method of the present invention can be utilized by any provider, seller, or lessor, of goods, products, and/or services, in order to ascertain the creditworthiness of a customer or client. The apparatus and method of the present invention can also be utilized in order to protect against accounts receivable losses, to eliminate the need for self-insurance of accounts receivable, and to eliminate the need to seek protection against receivables losses from specialist broker networks. The apparatus and method of the present invention can also provide financial information, services, or products, which can be readily accepted by trading parties of any kind or type.

The apparatus and method of the present invention can also provide for an automated system for evaluating the creditworthiness of a customer or client. The apparatus and method of the present invention can also be utilized in order to establish customer-specific or client-specific credit limits and trade credit insurance policies having smaller or no policy deductibles. The apparatus and method of the present invention can also be utilized in order to drastically reduce or eliminate administrative efforts needed to manage accounts receivables.

The present invention can also provide information needed for underwriting and creating trade credit insurance policies. The apparatus and method of the present invention can also be utilized in order to provide for the automated underwriting, generation, delivery, and claims processing, of or for trade credit insurance policies.

As used herein the terms “user”, “individual”, and “business entity”, or the plurals of same, refer to any user, users, individual, individuals, business entity, and/or business entities, or trade credit insurance brokers or agents, who or which utilize the present invention in order to obtain any of the information, trade credit information, trade credit insurance information, and/or trade credit insurance policies, described herein as being provided by the apparatus and method of the present invention.

As used herein, the terms “administrator” and “operator”, or the plurals of same, refer to any administrator, administrators, operator, and/or operators, who or which operate or administer the operation of the apparatus and method of the present invention.

As used herein, the term “third party information provider”, or the plural of same, refers to providers, information sources, and/or insurance providers, of any of the respective information, credit information, underwriting information, and/or trade credit insurance policies, described herein. Any provider can also be a user or operator as the respective terms are defined herein.

As used herein, the term “third party service provider”, or the plural of same, refers to providers of third party services such as, for example, collection services, collection agents or agencies, and/or insurance claims agents or agencies.

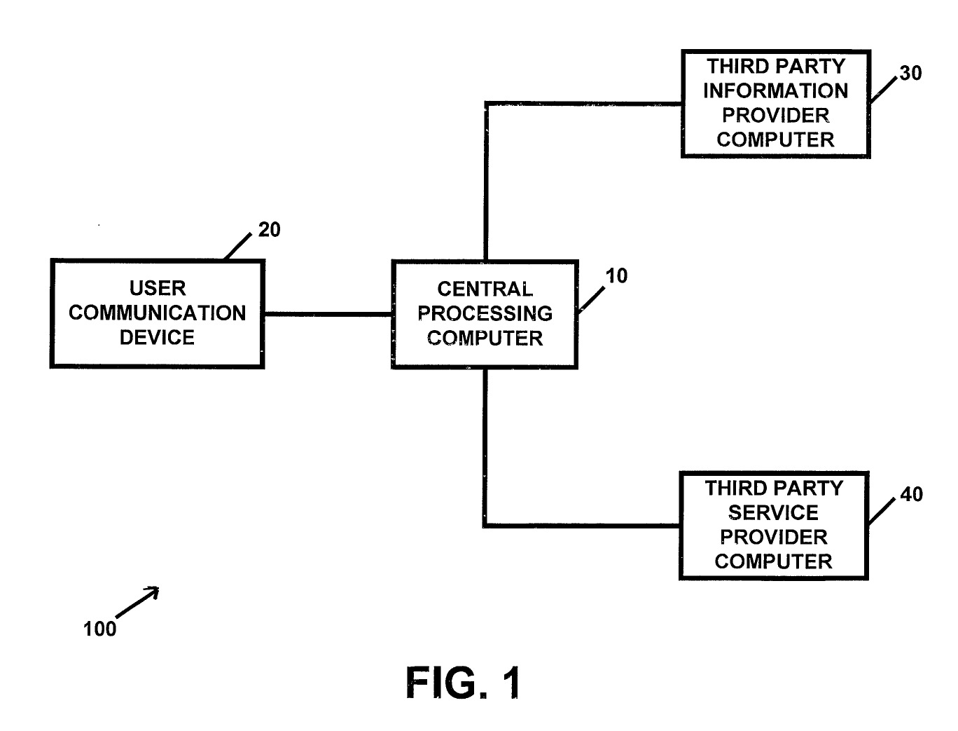

FIG. 1 illustrates the apparatus of the present invention which is designated generally by the reference number 100, in block diagram form. With reference to FIG. 1, the apparatus 100 includes a central processing computer 10. The central processing computer 10 can be any computer, computer system, network computer, server computer, and/or web site hosting computer, suitable for performing any of the functions and processing routines described herein. The central processing computer(s) 10 can be used by and/or can be associated with, any of the operators or administrators who or which provide the information, services, or products, described herein.

The central processing computer 10 can also include any number of computers, computer systems, network computers, and/or server computers. Any number of central processing computers 10 can be utilized in conjunction with the apparatus and method of the present invention.

The apparatus 100 also includes a user computer or communication device 20 (hereinafter referred to as “user communication device 20”). The user communication device 20 can be utilized by, and/or can be associated with, any of the herein-described users or individuals who or which utilize the apparatus 100.

The user communication device 20 can be any computer or communication device for facilitating a user's or an individual's accessing of the central processing computer 10 and obtaining of any of the information, trade credit information, trade credit insurance information, and/or trade credit insurance policies, which are described herein as being provided by the apparatus 100 and/or the central processing computer 10. The apparatus 100 can include any number of user communications devices 20.

The apparatus 100 can also include an information provider computer 30 which can be utilized by, and/or which can be associated with, any of the herein-described third party information providers. The third party information providers can include credit information or trade credit information sources or providers, collection agents or agencies, collection information sources or providers, claims processing information sources or providers, accounting information sources or providers, billing information sources or providers, trade credit insurance underwriters or providers, trade credit insurance brokers, trade associations, state and other export chambers, financial institutions and intermediaries, and/or transportation companies or entities.

The third party information provider computer 30 can be associated with, or can be utilized by, any of the herein-described third party information sources or providers in order to provide information to the central processing computer 10. The apparatus 100 can include any number of third party information provider computers 30.

The apparatus 100 can also include a third party service provider computer 40 which can be utilized by, and/or which can be associated with, any of the herein-described third party service providers. The third party service providers can include collection agents or agencies, and/or insurance claims agents or agencies.

The third party service provider computer 40 can be associated with, or can be utilized by, any of the herein-described service providers in order to provide information to the central processing computer 10. The apparatus 100 can include any number of third party service provider computers 40.

The user communication device(s) 20 can communicate with and/or can be linked to the central processing computer 10 on or over any suitable communication network or system. The central processing computer 20 can also communicate with and/or can be linked to any of the herein described third party information provider computers 30 and any of the herein-described third party service provider computers 40 on, or over, any suitable communication network or system.

In the preferred embodiment, the apparatus 100 can be utilized on, or over, the Internet and/or the World Wide Web. The apparatus 100 can also be utilized on, or over, any communication network or system, or any telecommunication network or system. The apparatus 100 can also be utilized on, or over, any communication network or platform. The apparatus and method of the present invention, in the preferred embodiment, can also provide information in real time or otherwise.

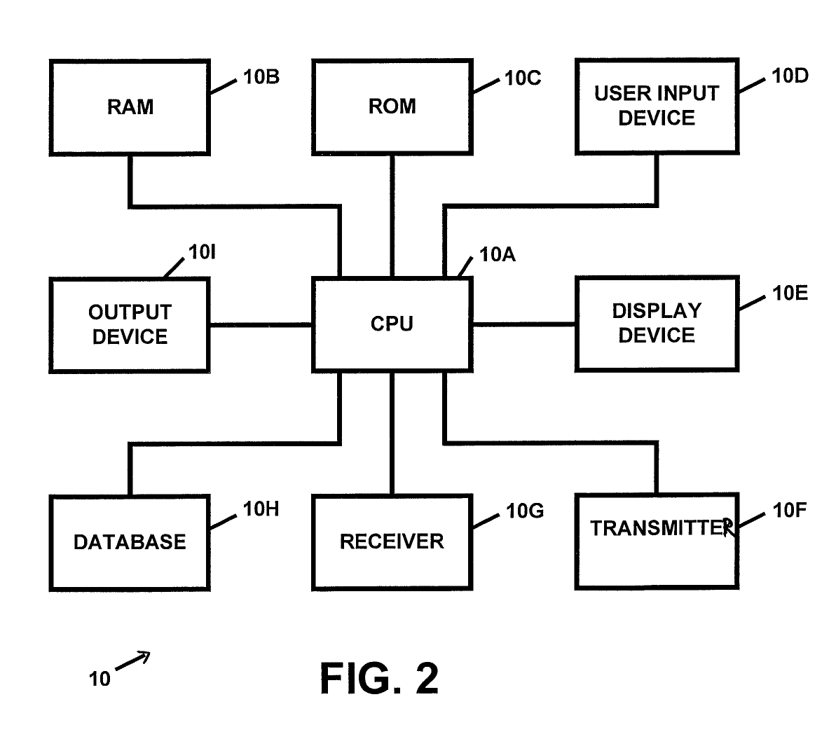

FIG. 2 illustrates the central processing computer 10 of FIG. 1, in block diagram form. With reference to FIG. 2, the central processing computer 10 includes a central processing unit (CPU) 10A, a random access memory (RAM) device 10B, a read only memory (ROM) device 10C, a user input device 10D, such as a keyboard, a mouse, and/or a pointing device, a display device 10E, a transmitter 10F and a receiver 10G for facilitating network communication with any of the user communication devices 20 and/or with any of the third party information provider computers 30 or third party service provider computers 40, and a database 10H for storing any of the data and/or information needed and/or desired for performing the functions and/or processing routines described herein.

The database 10H of the central processing computer 10 can contain user information, user name information, user contact information, user customer or client information, user accounts receivables information, customer or client information, customer or client name information, customer or client contact information, customer or client credit information, customer or client credit rating information, provider information, provider name information, and provider contact information.

The database 10H can also contain information for providing a link or links to any of the above-described information which may be stored at, or which may reside on, any of the third party information provider computers 30 or databases and/or any of the third party service provider computers 40 or databases.

The database 10H can also contain data and/or information concerning any users, individuals, applicants, buyers, customers, and clients, as well as credit information, credit limits, e-commerce purchases, for or corresponding to any of the above-described users, individuals, applicants, buyers, customers, and clients. The database 10H can also include programs for performing any of the processing routines described herein as being performed by the apparatus 100 or by the central processing computer 10.

The database 10H can also contain claim data and/or information, accounts receivable information, accounts receivable non-payment information, and/or any other information relating to any of the above-described users, individuals, applicants, buyers, customers, clients.

The database 10H can also contain policy/buyer data and/or information for any trade credit insurance information, information for generating trade credit limits, trade credit insurance policies, information for underwriting trade credit insurance policies, information for processing trade credit insurance claims, information for insurance company accounting purposes or other organization credit data or information, and/or information from, or available at, third party databases or computers.

The database 10H can also contain collections data and/or information, billing information, accounting information, and claims information, for or regarding any of the herein-described users, individuals, applicants, buyers, customers, and clients.

The database 10H can also contain risk management data and/or information, claims tracking information, underwriter monitoring information, underwriting programs, collection information, collection management information, insurance policy information, insurance policy form information, insurance policy premium information, insurance policy premium discount information, insurance claim submission and processing information, uncollected or unpaid account receivables information, financial management information, invoice or billing information, trade credit insurance premium quoting and submission information, and/or trade credit insurance policy maintenance information.

The database 10H can also contain premium booking compliance and/or standards data and/or information, credit or credit rating evaluation data and/or information, and credit exposure data and/or information.

The database 10H can also contain data and/or information regarding international trade, international transactions, and foreign trade patterns. The database 10H can also contain data and/or information for, or regarding, foreign exchange rates and foreign currencies (i.e. the European monetary unit (EMU) and other foreign country or regional currencies).

The database 10H can also contain data and/or information regarding U.S. and foreign credit data limits. The database 10H can also contain data and/or information regarding any of the herein-described providers, trade organizations, and trade associations. The database 10H can also contain data and/or information regarding import and export laws, rules, regulations, and compliance information.

The database 10H can also contain data and/or information regarding links to any of the herein-described information which may reside and/or be stored at external databases or information sources. The database 10H can also contain links or linking information to any computers, server computers, or web sites, which can be associated with any of the providers or information sources from which any of the herein-described data and/or information can be obtained.

The database 10H can also contain data and/or information for determining a user's or an individual's eligibility to obtain trade credit insurance.

The database 10H can also contain any data and/or information needed and/or desired for enabling the central processing computer 10 and/or the apparatus 100 to perform any of the processing routines and/or functionality described herein.

With reference once again to FIG. 2, the central processing computer 10 also includes an output device 101, such as a printer.

The apparatus and method of the present invention can be utilized by a user in order to manage its trade credit or trade credit portfolio. The apparatus and method of the present invention can also provide a credit limit information for a customer or client of a user. The apparatus and method of the present invention can also provide an insurance product which can be in the form of a trade credit insurance policy which can provide an insured user with protection against unpaid accounts receivables, such as insolvency/bankruptcy or protected default. The apparatus and method of the present invention and/or the trade credit insurance policy which can be offered thereby can provide a user with the ability to manage its trade credit risk and/or trade credit portfolio, in an effective and efficient manner.

In a preferred embodiment, the apparatus and method of the present invention can be utilized in order to provide a user with a credit report which comprises a credit decision, a credit decision report, a credit limit, and/or other credit-related information of, or relating to, a customer or a client. The credit report can also contain any other data and/or information which can typically be found in such a credit report and which may come from a third party source.

In the preferred embodiment, the apparatus and method of the present invention can also provide the above-described credit report in real time, such as by electronic transmission. In another preferred embodiment, the apparatus and method of the present invention can also provide the above-described credit report to a user in a non-real-time manner, such as via an electronic mail message or by fax, if desired or appropriate.

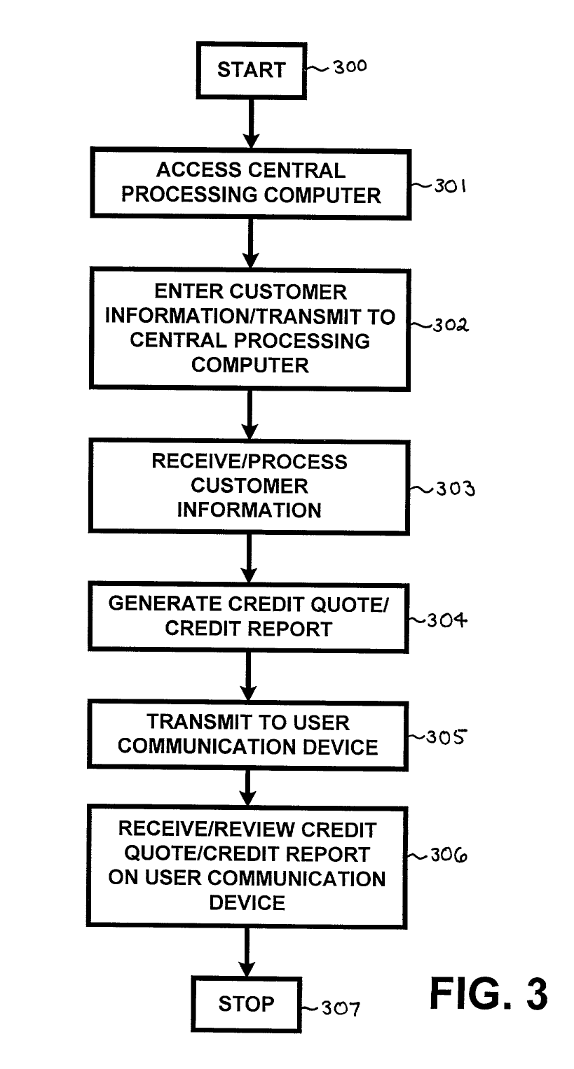

FIG. 3 illustrates a preferred embodiment method for utilizing the apparatus 100 of the present invention, in flow diagram form. With reference to FIG. 3, the operation of the apparatus commences at step 300. At step 301, a user can access the central processing computer 10 via the user communication device 20.

At step 302, the user can enter information regarding a customer, client, prospective customer, or prospective client (hereinafter referred to as the “customer”), for whom the user desires to obtain trade credit information. For example, the user can enter the name or other identifying information of, or corresponding to, the customer. At step 302, the information regarding the customer is also transmitted to the central processing computer 10.

At step 303, the central processing computer 10 will receive and process the user entered customer information. At step 303, the central processing computer 10 will process the user entered customer information and match the customer with trade credit information which corresponds to, or which is related to, the customer. At step 303, the central processing computer 10 can identify, “look-up”, or match, the customer with the customer's trade credit information, which may be stored in the database 10H of the central processing computer 10 or which may be stored at, or obtained from, any of the third party information provider computers 30.

At step 303, for example, the central processing computer 10 can obtain information from, or monitor information regarding the customer at, a third party information provider computer 30 such as via a link to third party credit information source or computer. At step 303, the central processing computer will generally verify the identity of the customer, such as by matching the customer's name and address with various identifiers which may differ from country to country, before accessing the trade credit information which corresponds to, or is related to the customer.

At step 304, the central processing computer 10 will generate a credit report which may include a credit quote regarding the customer. The credit report can also include the information regarding the customer's trade credit standing, trade credit rating, trade credit creditworthiness, credit limit, and/or any other related information which may be of interest to the user. Other financial information, such as the Standard Information Code (SIC) may also be included with the credit quote or credit report.

At step 305, the credit report can be transmitted to the user communication device 20 associated with the user. The credit report can be transmitted to the user communication device 20 in real-time, such as by computer-to-computer electronic transmission. The credit report can also be transmitted to the user communication device 20 in a non-real-time manner, such as via an electronic mail (e-mail) message or by facsimile (fax) transmission. At step 306, the user can receive and review the trade credit information or credit limit information which is contained in the credit report. The credit report produced as described above constitutes a credit decision for one or more customers and may include a recommended credit limit and possibly recommended terms of sale.

Thereafter, the operation of the apparatus 100 will cease at step 307.

In another preferred embodiment, the user can, at step 306, request information regarding another customer and the above-described processes of steps 302 through 306 can be repeated.

In still another preferred embodiment, the central processing computer 10, at step 305, can provide the user with a cost for purchasing the credit report, and inquire as to whether the user desires to purchase the credit report. The user can, thereafter, decide whether or not to purchase the credit report. If the user decides to purchase the credit report, the user can receive same at step 306. Thereafter, the user can request information regarding a different customer or exit from the central processing computer 10.

In another preferred embodiment, the apparatus and method of the present invention can generate a trade credit insurance policy for providing an insured with protection against uncollected accounts receivables. The apparatus and method of the present invention can generate a trade credit insurance policy and make same available for purchase by a user, in real-time. In another preferred embodiment, the apparatus and method of the present invention can also generate a trade credit insurance policy and make same available for purchase to a user in a non-real-time manner, if desired or appropriate.

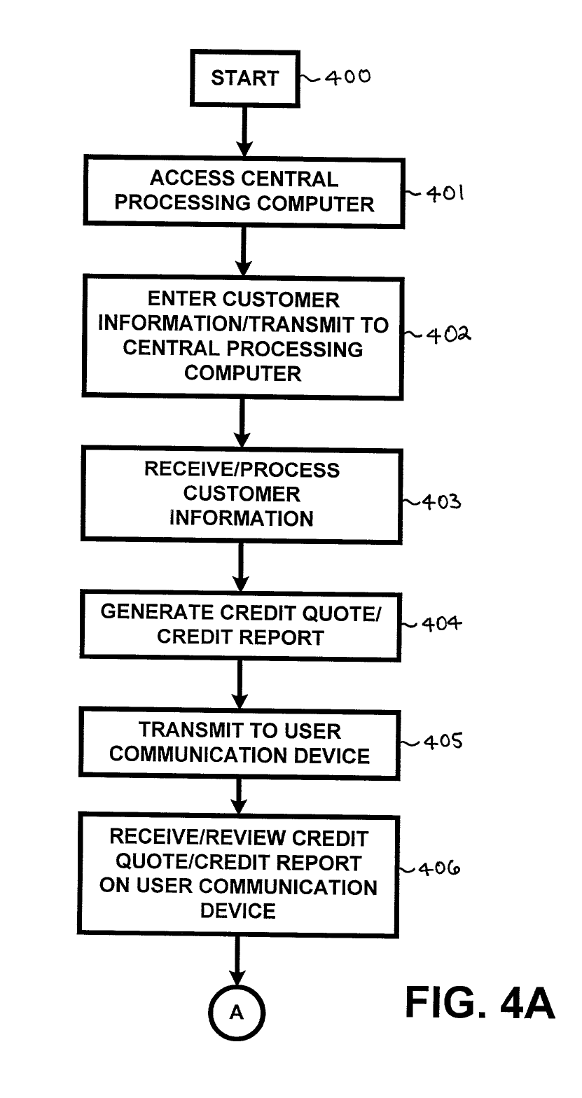

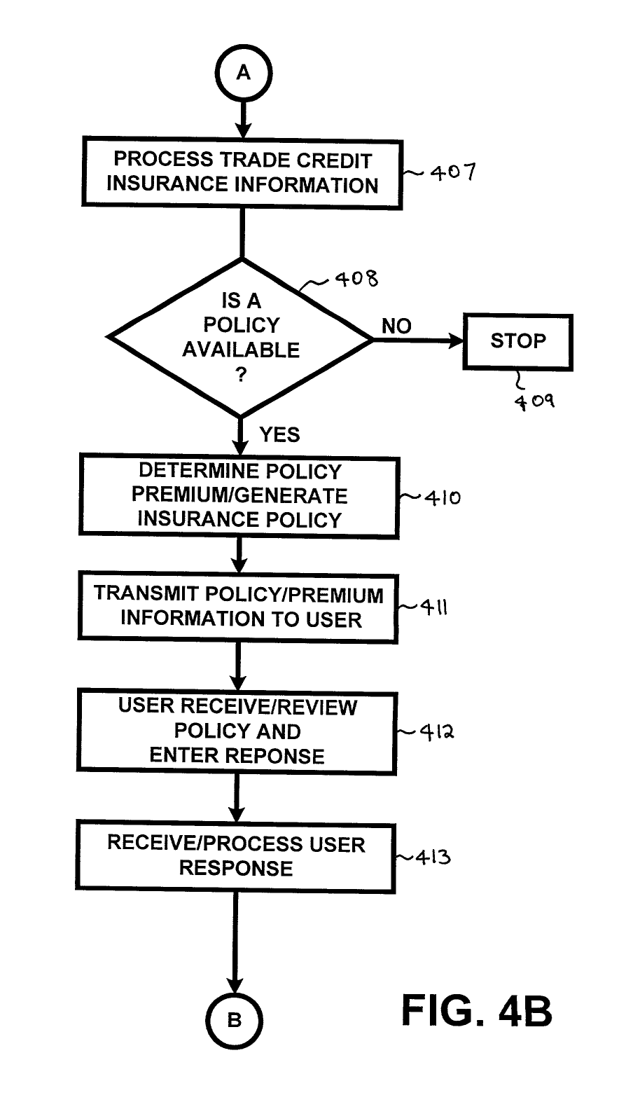

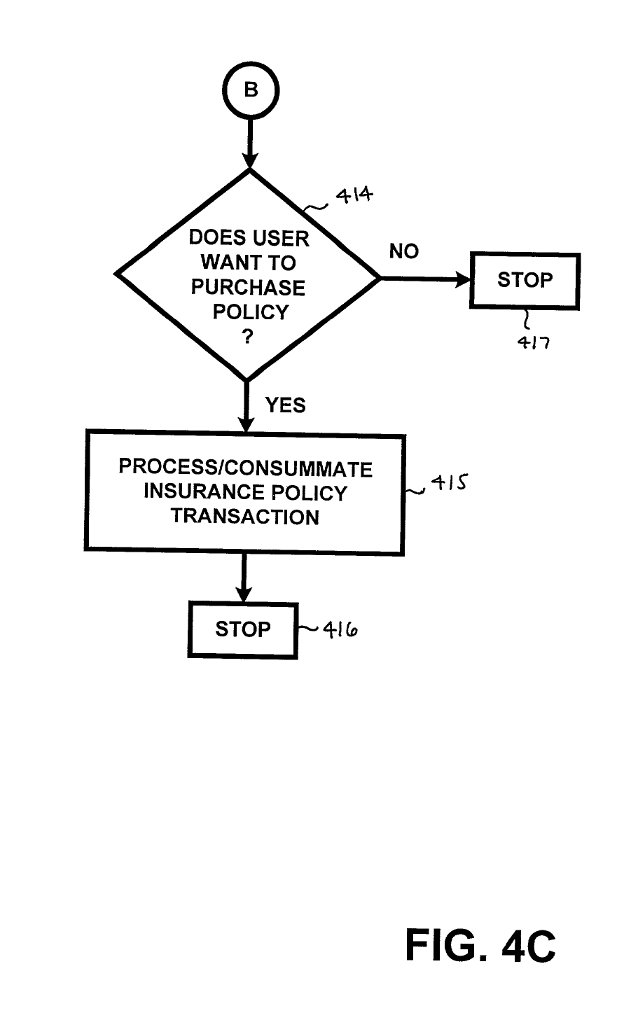

FIGS. 4A, 4B and 4C illustrate another preferred embodiment method for utilizing the apparatus 100 of the present invention, in flow diagram form. With reference to FIGS. 4A, 4B and 4C, the operation of the apparatus 100 commences at step 400. At step 401, a user can access the central processing computer 10 via the user communication device 20.

At step 402, the user can enter information regarding a customer, client, prospective customer, or prospective client (hereinafter referred to a the “customer”), for whom the user wants to obtain trade credit information. For example, the user can enter the name or other identifying information of, or corresponding to, the customer. At step 402, the information regarding the customer is also transmitted to the central processing computer 10.

At step 403, the central processing computer 10 will receive and process the user entered customer information. At step 403, the central processing computer 10 will process the user entered customer information and match the customer with trade credit information which corresponds to, or which is related to, the customer.

At step 403, the central processing computer 10 can identify, “look-up”, or match, the customer with the customer's trade credit information or credit limit which may be stored in the database 10H of the central processing computer 10 or which may be stored at, or which may be obtained from, any of the third party information provider computers 30. At step 403, for example, the central processing computer 10 can obtain information from, or monitor information, regarding the customer at a third party information provider computer 30 such as via a link to a third party credit information source or computer. Verification steps, as previously described, are generally carried out during this step as well.

At step 404, the central processing computer 10 will generate a credit report which may include a credit quote regarding the customer. The credit report can include information regarding the customer's trade credit standing, trade credit rating, trade credit creditworthiness, credit limit, and/or any other related information which may be of interest to the user.

At step 405, the credit report can be transmitted to the user communication device 20 associated with the user. The trade credit report can be transmitted to the user communication device 20 in real-time, such as by computer-to-computer electronic transmission.

The trade credit report can also be transmitted to the user communication device 20 in a non-real-time manner, such as via an electronic mail (e-mail) message or by facsimile (fax) transmission. At step 406, the user can receive and review the trade credit information which is contained in the credit report. Thereafter, the operation of the apparatus 100 will proceed to step 407.

At step 407, the central processing computer 10 will process the information regarding the user in conjunction with the customer trade credit information in order to determine whether the operator or administrator can provide a trade credit insurance policy to protect the user against non-payment or credit default by the customer. The central processing computer 10 can process information regarding the user and/or the customer, such as the customer's past credit history, past defaults by the customer, legal proceedings involving the customer, how the customer is doing relative to its peer group, etc.

Based on criteria that are known to those skilled in the art, at step 408, the central processing computer 10 will determine if a trade credit insurance policy is available and can be offered to the user. If, at step 408, it is determined that a trade credit insurance policy is not available or cannot be offered to the user, then the operation of the apparatus 100 will cease at step 409.

If, however, at step 408, it is determined that a trade credit insurance policy is available and can be offered to the user, then the operation will proceed to step 410 and the central processing computer 10 will determine a policy premium and generate a trade credit insurance policy.

The policy premium and corresponding trade credit insurance policy can be determined or generated from information stored in the database 10H and/or from information available at any appropriate third party information provider computer 30 or database of same. The trade credit insurance policy and policy premium information can include policy coverage, terms and conditions, underwriting information, policy deductible, if any, and any other premium or cost information associated with the trade credit insurance policy.

At step 411, the trade credit insurance policy and policy premium information can be transmitted to the user communication device 20. In the preferred embodiment, the trade credit insurance policy and policy premium information can be transmitted to the user communication device 20 in real-time, such as by computer-to-computer electronic transmission. In another preferred embodiment, the trade credit insurance policy and policy premium information can also be transmitted to the user communication device 20 in a non-real-time manner, such as by e-mail message or by facsimile (fax) transmission.

At step 412, the user can receive and review the trade credit insurance policy and policy premium information and determine whether or not to purchase the offered trade credit insurance policy. At step 412, the user can transmit information regarding whether or not to purchase the offered trade credit insurance policy. At step 413, the central processing computer 10 can receive and process the user's decision information.

At step 414, the central processing computer 10 will determine whether the user has decided to purchase the offered trade credit insurance policy. If, at step 414, it is determined that the user has decided to purchase the offered trade credit insurance policy, the operation will proceed to step 415 and the central processing computer 10 will process and/or consummate the trade credit insurance policy transaction.

At step 415, the central processing computer 10 can obtain user payment information or a payment identifier and/or otherwise process payment or effectuate the purchase of the trade credit insurance policy. At step 415, the central processing computer 10 can also transmit a copy of the trade credit insurance policy to the user communication device, such as via a facsimile transmission, an e-mail message, or other transmission, electronic and/or otherwise. At step 415, the central processing computer 10 can also store the trade credit insurance policy of the user in the database 10H for later use or processing. Thereafter, the operation of the apparatus 100 will cease at step 416.

If, however, at step 414, it is determined that the user has declined to purchase the offered trade credit insurance policy, then the operation of the apparatus will cease at step 417.

In the above-described manner, the apparatus and method of the present invention can facilitate the purchase and sale of trade credit insurance policies on-line and/or in a network environment.

In another preferred embodiment, the apparatus and method of the present invention can be utilized in order to monitor a user's customers or clients and provide notification of a problem which may signify that a respective customer(s) or client(s) may be unable to meet its financial obligations under a trade credit agreement with the user. This can, for example, occur if a customer or client has defaulted on a financial obligation or has otherwise experienced a downgrade in its credit rating.

In a preferred embodiment, it is envisioned that a user's accounts receivables information and a customer's accounts payables information can be maintained by, and/or be stored at, the central processing computer 10, a third party information provider computer 30, and/or a third party service provider computer 40. As payments are received on a respective user's account, the user's accounts receivables information and the customer's accounts payables information can be updated so as to reflect the payment.

In the preferred embodiment, the apparatus and method of the present invention can perform or provide the herein-described monitoring and/or notification functions, in real-time. In another preferred embodiment, the apparatus and method of the present invention can also perform or provide the herein-described monitoring and/or notification functions in a non-real-time manner, if desired or appropriate.

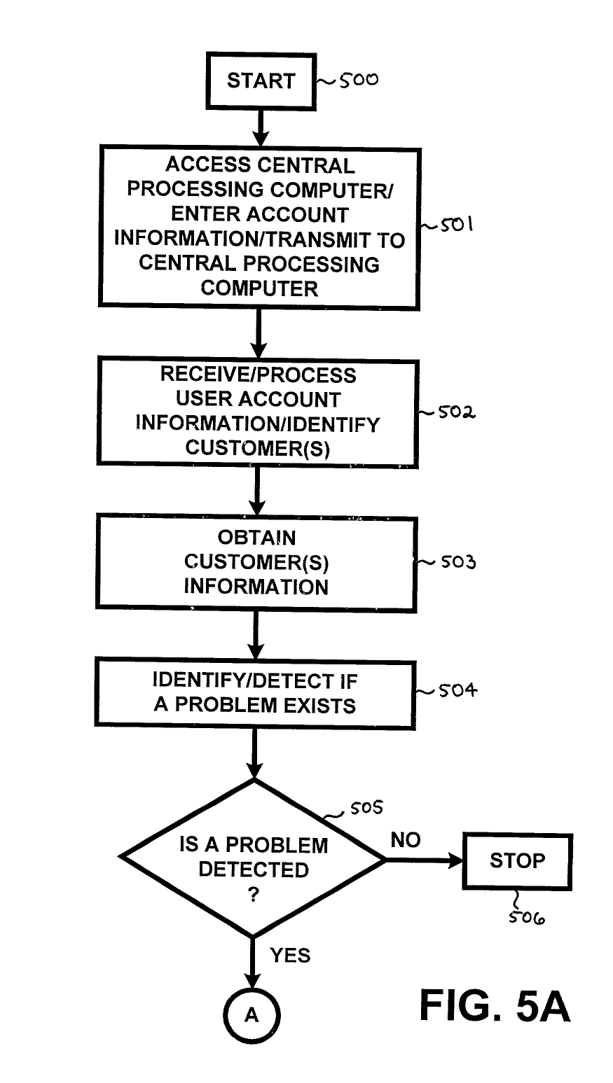

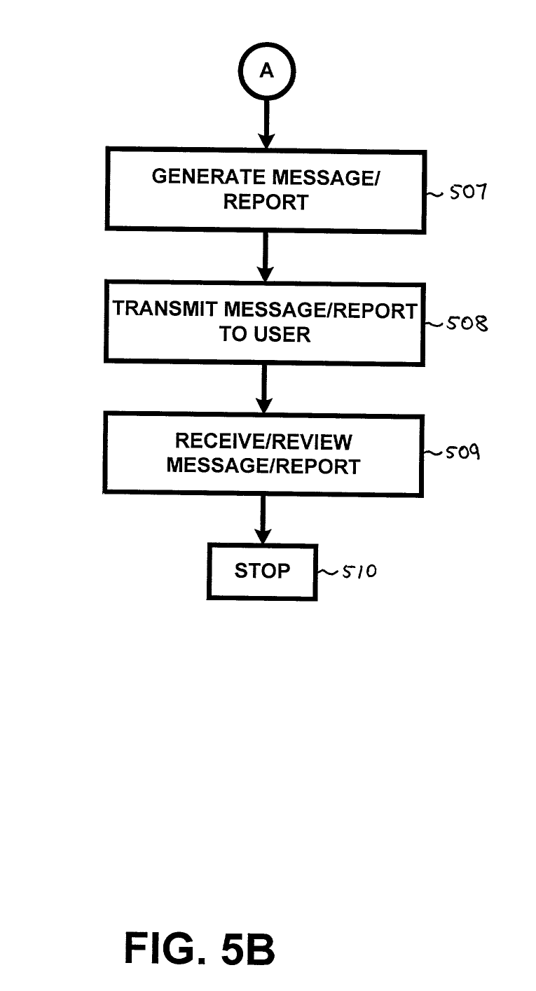

FIG. 5 illustrates another preferred embodiment method for utilizing the apparatus 100 of the present invention, in flow diagram form. In the embodiment of FIG. 5, it is understood that a user has an existing account with the apparatus 100.

With reference to FIG. 5, the operation of the apparatus 100 commences at step 500. At step 501, the user accesses the central processing computer 10 via the user communication device 20. At step 501, the user also enters his, her, or its, account identification information and transmits same the central processing computer 10. At step 502, the central processing computer 10 can receive and process the user's account identification information. At step 502, the central processing computer 10 can identify the user's customer or customers.

At step 503, the central processing computer 10 can obtain information regarding each of the user's customers. The information can be obtained from the database 10H, from a third party information provider computer 30 or database, or from a third party service provider computer 40 or database. For example, credit information, credit rating information, credit rating downgrade, or payment default information, can be obtained from a credit rating or credit monitoring service.

At step 504, the central processing computer 10 can process the information and identify or detect if any problems exist which may warrant providing notification to the user. A problem, for example, can be a customer's default or a downgrade in a customer s credit rating. At step 505, the central processing computer 10 will determine whether a problem exists which may warrant providing notification to the user.

If, at step 505, no problem with the customer is detected, the operation of the apparatus 100 will cease at step 506. In an alternate embodiment, the above process described in steps 503 through 505 can be repeated for any additional customers identified in the user's account. When information regarding all of the user's customers of interest have been processed, the operation of the apparatus 100 will cease.

If, at step 505, it is determined that a problem with a customer is detected, the operation of the central processing computer 10 will proceed to step 507. At step 507, the central processing computer 10 will generate an appropriate message or report. At step 508, the message or report can be transmitted to the user communication device 20. The message or report can be transmitted in real-time such as by computer-to-computer electronic transmission. The message or report can also be provided in non-real-time, such as via an e-mail message, via fax, by mail, etc.

At step 509, the user can receive and review the information contained in the message or report. Thereafter, the operation of the apparatus 100 will cease at step 510.

When the user purchases trade credit insurance as per the steps illustrated in FIG. 4, the monitoring operation illustrated in FIG. 5 is performed automatically at a frequency set by the insurer, e.g., daily, so that the user will be informed almost immediately if there has been a deterioration in the financial condition of any of the user's customers. On the other hand, the monitoring module illustrated in FIG. 5 may be purchased by a user separately from trade credit insurance. In this case, the user can decide how often the monitoring operation should be performed, e.g., daily, weekly, etc., thereby to monitor the financial condition of user's customers.

In another preferred embodiment, the apparatus and method of the present invention can also perform or provide collections management functions for, or on behalf of, a user in the event of a non-payment or a default on the part of a customer. In the preferred embodiment, the apparatus and method of the present invention can perform or provide collections management functions for, or on behalf of, a user, in real-time. In another preferred embodiment, the apparatus and method of the present invention can also perform or provide collections management functions for, or on behalf of, a user, in a non-real-time manner, if desired or appropriate.

The collections management functions can include electronically and/or otherwise referring a delinquent customer to a collection agent or agency and, after a pre-specified period of time has elapsed for effectuating collection from the customer, filing or submitting a claim under a user's trade credit insurance policy for any uncollected amounts.

The insured informs about non-paying customer-insurance-in future, insurance company will be paying directly to insurance company-ins, company will trigger collections.

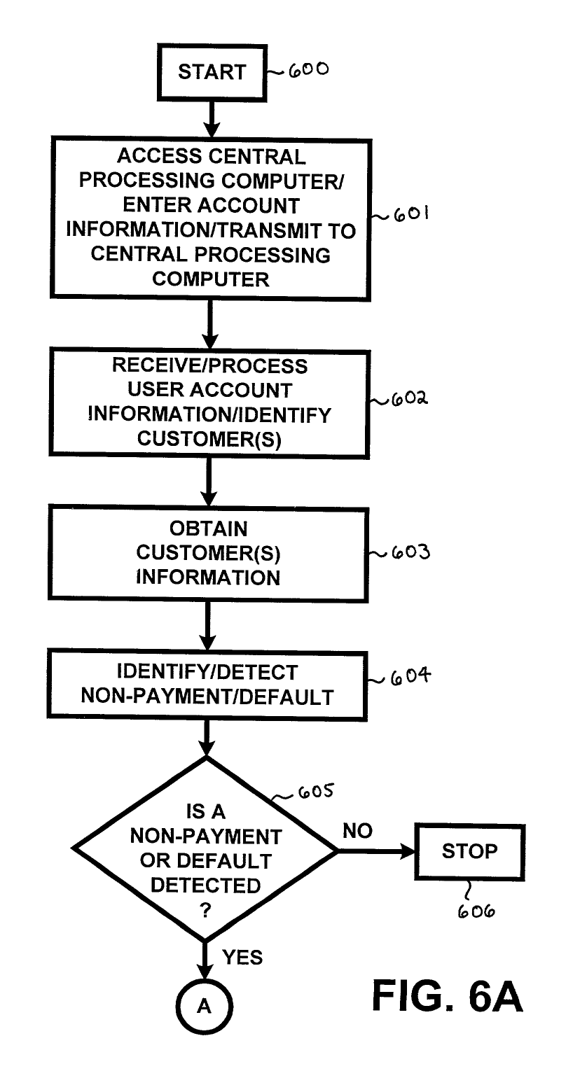

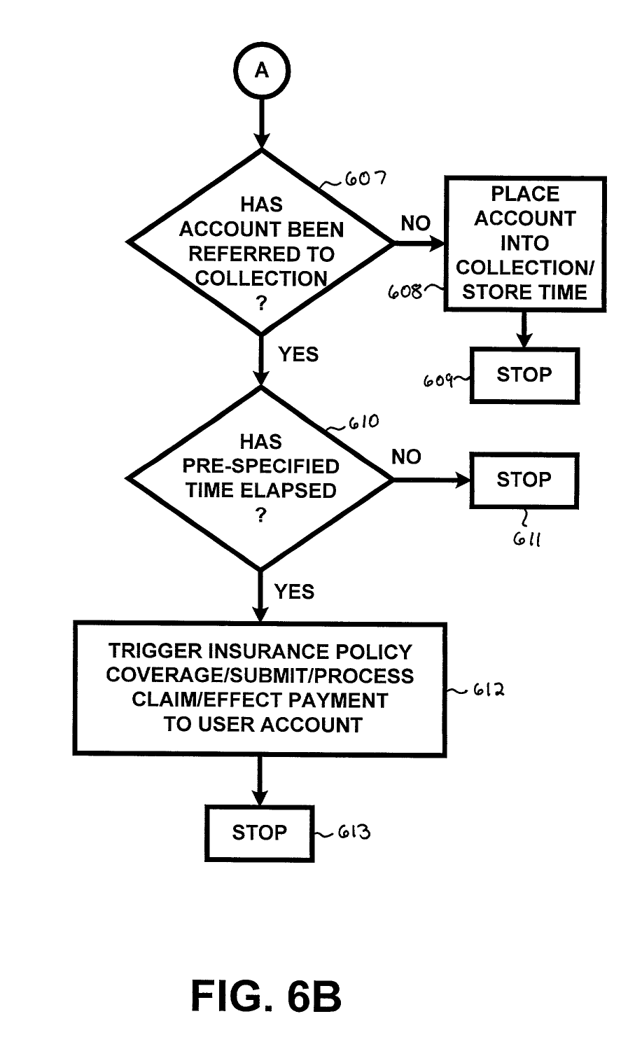

FIG. 6 illustrates another preferred embodiment method for utilizing the apparatus 100 of the present invention, in flow diagram form. In the embodiment of FIG. 6, it is understood that a user has an existing account with the apparatus 100 and has purchased or otherwise obtained a trade credit insurance policy for a customer or customers.

With reference to FIG. 6, the operation of the apparatus 100 commences at step 600. At step 601, the user accesses the central processing computer 10 via the user communication device 20. At step 601, the user also enters his, her, or its, account identification information and transmits same the central processing computer 10. At step 602, the central processing computer 10 can receive and process the user's account identification information. At step 602, the central processing computer 10 can identify the user's customer or customers.

At step 603, the central processing computer 10 can obtain and/or process information regarding whether a customer or customers have failed to make a required or scheduled payment to the user. This information is usually provided by the user. However, in other embodiments of the invention, payments by the user's customers will be made utilizing a facility provided by the insurer, for example, access to automated clearinghouse systems, so that the insurer will know immediately when a customer is delinquent in its payments and can initiate collection steps as described below.

At step 604, the central processing computer 10 can process the information and identify or detect if a customer or customers have missed a payment(s) to the user or have otherwise defaulted in fulfilling an obligation(s) under a respective trade credit agreement(s). At step 605, the central processing computer 10 will determine if a non-payment or default is detected for a customer or customers.

If, at step 605, no non-payment or default involving the customer or customers is detected, the operation of the apparatus 100 will cease at step 606. In an alternate embodiment, the above-described processes of steps 603 through 605 can be repeated for any additional customers or groups of customers which have been identified in the user's account. When information regarding all of the user's customers of interest has been processed, the operation of the apparatus 100 will cease.

If, at step 605, it is determined that a non-payment or a default by a customer or customers has occurred, the operation of the apparatus 100 will proceed to step 607. At step 607, the central processing computer 10 will determine whether the customer or the account has been previously referred to a collection agent or agency. If, at step 607, the customer or account has not been previously referred to a collection agent or agency, the central processing computer 10 will proceed to step 608 and will place the customer or the account into collection.

The customer or account can be placed in, or referred to, a collection agent or agency by the central processing computer 10, electronically and/or via any other appropriate manner. For example, the central processing computer 10 can initiate a collections process by transmitting a message to a third party service provider computer 40 which is associated with a collection agency.

At step 608, the central processing computer 10 will also store information regarding the time at which the account was placed into collection. Thereafter, the operation of the apparatus 100 will cease at step 609.

If at step 607, the central processing computer 10 determines that the customer or the account has been previously placed into collection, the central processing computer 10 will proceed to step 610 and determine whether a pre-specified collection time period has elapsed. The time period can be pre-specified as, for example, ninety (90) days. If, at step 610, it is determined that the pre-specified collection time period has not elapsed, the operation of the apparatus 100 will cease at step 611.

If, however, at step 610, it is determined that the pre-specified collection time period has elapsed (i.e. the efforts of the collection agent or agency have been unsuccessful in collecting the account receivables), then the operation will proceed to step 612.

At step 612, the central processing computer 10 can effectuate or trigger a claim submission under the user's trade credit insurance policy which is currently in effect. At step 612, the central processing computer 10 can perform or effectuate any claim submission or verification activities for processing the insurance claim. At step 612, the central processing computer 10 can also facilitate a payment of the claim to the user or to the user's financial account. Thereafter, the operation of the apparatus 100 will cease at step 613.

As in the case of the other modules illustrated in FIGS. 3, 4, and 5, the collections module illustrated in FIG. 6 may be included as part of an integrated package purchased by the user, or may be purchased and utilized separately as a stand alone module.

The present invention provides an apparatus and method for providing a user with credit information, credit decision information, and/or other related information regarding a customer or client. The apparatus and method of the present invention can also provide a trade credit insurance policy for enabling a user to manage its trade credit exposure or risks.

The apparatus and method of the present invention can also monitor credit information regarding a user's customer or customers and provide notification to a user in the event that a customer or customers may become a credit risk to the user. The apparatus and method of the present invention can also provide collections management functions for a user in the event of a non-payment or default by a customer.

The apparatus and method of the present invention can provide automated customer or client underwriting processes for, or on behalf of, a user. The apparatus and method of the present invention can also monitor underwriting results and exposures for any of the herein-described users, customers, clients, or insurance policies, provided by the present invention.

The apparatus and method of the present invention can provide a user with real-time access and/or links to credit data and/or information. The present invention can also provide an on-line communications platform which can facilitate communications between any of the herein-described users or parties. The apparatus and method of the present invention can also provide access to collections data and/or information as well as provide access to credit data and/or information from multiple sources.

The apparatus and method of the present invention can also generate any documents, reports, insurance policies, notification messages, or any other information incidental thereto, for facilitating the operation of the present invention as described herein.

The apparatus and method of the present invention can also be utilized in a multinational or international environment and, hence, can provide any of the herein-described documents, reports, insurance policies, notification messages, or other information, in multiple languages. Any related and/or associated monetary information can also be provided in multiple currencies. The apparatus 100 and/or the central processing computer 10 can also perform currency conversions and/or currency calculations based on appropriate and/or then prevailing foreign exchange rates.

While the present invention has been described and illustrated in various preferred embodiments, such descriptions are merely illustrative of the present invention and are not to be construed to be limitations thereof. In this regard, the present invention encompasses any and all modifications, variations, and/or alternate embodiments, with the scope of the present invention being limited only by the claims which follow.

1. An apparatus for providing trade credit information, comprising:
a memory device for storing information regarding at least one of account information, account holder information, customer information, and customer trade credit information,
a receiver for receiving a request from an account holder for trade credit information regarding a customer;
a processor for processing said request for trade credit information in conjunction with said information stored in said memory device, wherein said processor generates a credit report for said customer; and
a transmitter for transmitting said credit report to a communication device associated with the account holder.

2. The apparatus of claim 1, wherein said processor processes said request for information in conjunction with at least one of credit information, trade credit information, customer information, customer credit history information, and customer credit rating information, obtained from at least one of a computer and a database associated with an external information source.

3. The apparatus of claim 1, wherein said credit report is transmitted as a facsimile transmission.

4. The apparatus of claim 1, wherein said credit report is transmitted as an electronic mail message.

5. The apparatus of claim 1, wherein said credit report is transmitted to the communication device associated with the account holder in real time.

6. The apparatus of claim 1, wherein said credit report contains an offer to purchase said credit report regarding the customer.

7. A method for providing trade credit information, comprising:
storing information regarding at least one of account information, account holder information, customer information, and customer trade credit information;
receiving a request from an account holder for trade credit information regarding a customer;
processing said request for trade credit information in conjunction with said stored information;
generating a credit report for said customer; and
transmitting said credit report to a communication device associated with the account holder.

8. The method of claim 7, further comprising:
processing said request for information in conjunction with at least one of credit information, trade credit information, customer information, customer credit history information, and customer credit rating information, obtained from at least one of a computer and a database associated with an external information source.

9. The method of claim 7, wherein said credit report is transmitted as a facsimile transmission.

10. The method of claim 7, wherein said credit report is transmitted as an electronic mail message.

11. The method of claim 7, wherein said credit report is transmitted to the communication device associated with the account holder in real time.

12. The method of claim 7, wherein said credit report contains an offer to purchase said credit report regarding the customer.

13. An apparatus for providing trade credit information, comprising:
a memory device for storing information regarding at least one of account information, account holder information, customer information, customer trade credit information, and trade credit insurance policy information;
a receiver for receiving a request from an account holder for trade credit information regarding a customer;
a processor for processing said request for trade credit information in conjunction with said information stored in said memory device, wherein said processor generates a credit report for said customer, and further wherein said processor processes information contained in said credit report in conjunction with said information stored in said memory device to determine whether a trade credit insurance policy can be provided to the account holder, and further wherein said processor generates a trade credit insurance report containing information regarding at least one of an offering of a trade credit insurance policy, a trade credit insurance policy, a policy premium, and a declination to offer a trade credit insurance policy; and
a transmitter for transmitting said trade credit insurance report to a communication device associated with the account holder.

14. The apparatus of claim 13, wherein said processor processes said request for information in conjunction with at least one of credit information, trade credit information, customer information, customer credit history information, customer credit rating information, insurance policy information, insurance policy premium information, and trade credit insurance underwriting information, obtained from at least one of a computer and a database associated with an external information source.

15. The apparatus of claim 13, wherein said trade credit insurance report is transmitted as a facsimile transmission.

16. The apparatus of claim 13, wherein said trade credit insurance report is transmitted as an electronic mail message.

17. The apparatus of claim 13, wherein said credit report is transmitted to the communication device associated with the account holder in real time.

18. The apparatus of claim 13, wherein said receiver receives a request to purchase said trade credit insurance policy, wherein said processor processes an insurance policy sales transaction involving said trade credit insurance policy, and further wherein said processor stores information regarding the trade credit insurance policy in the account holder's records.

19. A method for providing trade credit information, comprising:
storing information regarding at least one of account information, account holder information, customer information, customer trade credit information, and trade credit insurance policy information;
receiving a request from an account holder for trade credit information regarding a customer;
processing said request for trade credit information in conjunction with said stored information;
generating a credit report for said customer;
processing information contained in said credit report in conjunction with said stored information;
determining whether a trade credit insurance policy can be provided to the account holder;
generating a trade credit insurance report containing information regarding at least one of an offering of a trade credit insurance policy, a trade credit insurance policy, a policy premium, and a declination to offer a trade credit insurance policy; and
transmitting said trade credit insurance report to a communication device associated with the account holder.

20. The method of claim 19, further comprising:
processing said request for information in conjunction with at least one of credit information, trade credit information, customer information, customer credit history information, customer credit rating information, insurance policy information, insurance policy premium information, and trade credit insurance underwriting information, obtained from at least one of a computer and a database associated with an external information source.

21. The method of claim 19, wherein said trade credit insurance report is transmitted as a facsimile transmission.

22. The method of claim 19, wherein said trade credit insurance report is transmitted as an electronic mail message.

23. The method of claim 19, wherein said credit report is transmitted to the communication device associated with the account holder in real time.

24. The method of claim 19, further comprising:
receiving a request to purchase said trade credit insurance policy;
processing an insurance policy sales transaction involving said trade credit insurance policy; and
storing information regarding the trade credit insurance policy in the account holder's records.

25. An apparatus for providing trade credit information, comprising:
a memory device for storing information regarding at least one of account information, account holder information, customer information, customer trade credit information, customer payment information, customer non-payment information, and customer default information;
a receiver for receiving a request to monitor customer information;
a processor for processing said request to monitor customer information in conjunction with said information stored in said memory device, wherein said processor generates a customer report, and further wherein said customer report contains information regarding at least one of customer payment information, customer non-payment information, and customer default information, wherein said processor determines whether a customer has failed to make a payment of an accounts payable or has defaulted on an accounts payable, and further wherein said processor generates a notification message containing information regarding at least one of the customer's failure to make a payment on an accounts payable and the customer's default on an accounts payable; and
a transmitter for transmitting said notification message to a communication device associated with the account holder.

26. The apparatus of claim 25, wherein said processor processes said request to monitor a customer in conjunction with at least one of credit information, trade credit information, customer information, customer credit history information, customer credit rating information, customer payment information, customer non-payment information, and customer default information, obtained from at least one of a computer and a database associated with an external information source.

27. The apparatus of claim 25, wherein said notification message is transmitted as a facsimile transmission.

28. The apparatus of claim 25, wherein said notification message is transmitted as an electronic mail message.

29. The apparatus of claim 25, wherein notification message is transmitted to the communication device associated with the account holder in real time.

30. A method for providing trade credit information, comprising:
storing information regarding at least one of account information, account holder information, customer information, customer trade credit information, customer payment information, customer non-payment information, and customer default information;
receiving a request to monitor customer information;
processing said request to monitor customer information in conjunction with said stored information;
generating a customer report containing information regarding at least one of customer payment information, customer non-payment information, and customer default information;
determining whether a customer has failed to make a payment of an accounts payable or has defaulted on an accounts payable;
generating a notification message containing information regarding at least one of the customer's failure to make a payment on an accounts payable and the customer's default on an accounts payable; and
transmitting said notification message to a communication device associated with the account holder.

31. The method of claim 30, wherein said request to monitor a customer is processed in conjunction with at least one of credit information, trade credit information, customer information, customer credit history information, customer credit rating information, customer payment information, customer non-payment information, and customer default information, obtained from at least one of a computer and a database associated with an external information source.

32. The method of claim 30, wherein said notification message is transmitted as a facsimile transmission.

33. The method of claim 30, wherein said notification message is transmitted as an electronic mail message.

34. The method of claim 30, wherein said notification message is transmitted to the communication device associated with the account holder in real time.

35. An apparatus for providing trade credit information, comprising:
a memory device for storing information regarding at least one of account information, account holder information, customer information, customer trade credit information, customer payment information, customer non-payment information, and customer default information, accounts receivables information, accounts payables information, collection information, and trade credit insurance policy information;
a receiver for receiving a request to monitor a customer account;
a processor for processing said request to monitor a customer account in conjunction with said information stored in said memory device, wherein said processor determines whether an accounts receivable has not been satisfied by a customer, and further wherein said processor generates an account collection message for placing the customer into collection; and
a transmitter for transmitting said account collection message to a communication device associated with a collection agent.

36. The apparatus of claim 35, wherein said processor establishes a collection time period, and further wherein said processor detects an end of said collection time period.

37. The apparatus of claim 35, wherein said processor determines whether the accounts receivable has been satisfied at the end of said collection time period, and further wherein said processor generates a trade credit insurance policy claim, and further wherein said processor processes said trade credit insurance claim under a trade credit insurance policy held by the account holder.

38. The apparatus of claim 35, wherein said processor effects a financial transfer to a financial account associated with the account holder in satisfaction of said trade credit insurance claim.

39. A method for providing trade credit information, comprising:
storing information regarding at least one of account information, account holder information, customer information, customer trade credit information, customer payment information, customer non-payment information, and customer default information, accounts receivables information, accounts payables information, collection information, and trade credit insurance policy information;
receiving a request to monitor a customer account;
processing said request to monitor a customer account in conjunction with said stored information;
determining whether an accounts receivable has not been satisfied by a customer;
generating an account collection message for placing the customer into collection; and
transmitting said account collection message to a communication device associated with a collection agent.

40. The method of claim 39, further comprising:
establishing a collection time period; and
detecting an end of said collection time period.

41. The method of claim 39, further comprising:
determining whether the accounts receivable has been satisfied at the end of said collection time period;
generating a trade credit insurance policy claim; and
processing said trade credit insurance claim under a trade credit insurance policy held by the account holder.

42. The method of claim 39, further comprising:
effecting a financial transfer to a financial account associated with the account holder in satisfaction of said trade credit insurance claim.

43. An apparatus for providing trade credit information, comprising:
a memory device for storing information regarding at least one of account information, account holder information, customer information, and customer trade credit information;
a receiver for receiving a request regarding a customer;
a processor for processing said request in conjunction with said information stored in said memory device; and
a transmitter;
and wherein one or more of conditions (a), (b), (c) and (d) apply:
(a) wherein said request is for trade credit information from an account holder;
said processor generates a credit report; and
said transmitter transmits said credit report to a communication device associated with the account holder; or
(b) wherein said request is for trade credit information from an account holder;
said processor generates a credit report and further processes the information in the credit report in conjunction with the information stored in the memory device to determine whether a trade credit insurance policy can be provided to the account holder, and further generates a trade credit insurance report containing information regarding at least one of an offering of a trade credit insurance policy, a trade credit insurance policy, a policy premium, and a declination to offer a trade credit insurance policy; and
said transmitter transmits said trade credit insurance report to a communication device associated with the account holder; or
(c) wherein said request is a request to monitor customer information;
said processor generates a customer report, said customer report containing information regarding at least one of customer payment information, customer non-payment information, and customer default information, said processor further determines whether a customer has failed to make a payment of an accounts payable or has defaulted on an accounts payable, said processor further generates a notification message containing information regarding at least one of the customer's failure to make a payment on an accounts payable and the customer's default on an accounts payable; and
said transmitter transmits said notification message to a communication device associated with the account holder; or
(d) wherein said request is a request to monitor a customer account,
said processor determines whether an accounts payable has not been satisfied by a customer, in which case said processor generates an account collection message for placing the customer into collection, and
said transmitter transmits said account collection message to a communication device associated with a collection agent.

44. A method for providing trade credit information, comprising:
storing information regarding at least one of account information, account holder information, customer information, customer trade credit information, and trade credit policy information;
receiving a request for trade credit information regarding a customer; and
processing said request for trade credit information in conjunction with said stored information;
said method further comprising the steps defined in one or more of (a), (b), (c), and (d),
(a) generating a credit report for said customer; and
transmitting said credit report to a communication device associated with an account holder;
(b) generating a credit report for said customer;
processing information in said credit report in conjunction with said stored information;
determining whether a trade credit insurance policy can be provided to the account holder;
generating a trade credit insurance report containing information regarding at least one of an offering of a trade credit insurance policy, a trade credit insurance policy, a policy premium, and a declination to offer a trade credit insurance policy; and
transmitting said trade credit insurance report to a communication device associated with an account holder;
(c) receiving a request to monitor customer information;
processing the request to monitor customer information in conjunction with said stored information;
generating a customer report containing information regarding at least one of customer payment information, customer non-payment information, and customer default information;
determining whether a customer has failed to make a payment of an accounts payable or has defaulted on an accounts payable;
generating a notification message regarding at least one of the customer's failure to make a payment on an accounts payable and the customer's default on an accounts payable; and
transmitting said notification message to a communication device associated with an account holder;
(d) receiving a request to monitor a customer account;
processing said request to monitor a customer account in conjunction with said stored information;
determining whether an account payable as been satisfied by a customer;
generating an account collection message for placing the customer into collection; and
transmitting said account collection message to a communication device associated with a collection agent.
